(19) United States
(12) Patent Application Publication
(10) Pub. No.: US 2014/0156679 A1
(43) Pub. Date: Jun. 5, 2014

(54) SECURE MOLECULAR SIMILARITY CALCULATIONS

(71) Applicant: OpenEye Scientific Software, Inc., Santa Fe, NM (US)

(72) Inventors: Robert W. Tolbert, Santa Fe, NM (US); Joseph J. Corkery, Waban, MA (US); Anthony Nicholls, Santa Fe, NM (US); Kevin Schmidt, Acton, MA (US); Brian Kelley, Boston, MA (US)

(73) Assignee: OpenEye Scientific Software, Inc., Santa Fe, NM (US)

(21) Appl. No.: 13/920,010

(22) Filed: Jun. 17, 2013

Related U.S. Application Data
(60) Provisional application No. 61/660,783, filed on Jun. 17, 2012.

(51) Int. Cl. G06F 17/30; H04L 29/06

(52) U.S. Cl. CPC G06F 17/30595; G06F 17/30569; H04L 65/403
USPC 707/749; 707/756; 709/204

(57) ABSTRACT

Methods of securing the calculation of pairwise molecular similarity coefficients between molecules, from similarity measures that are based on 3-dimensional or 2-dimensional molecular properties and/or physicochemical properties, condensed into a fingerprint or bit-string representation, in such a way that a third party cannot deduce information about the underlying molecular structures. The apparatus and process are particularly applicable to generating secured or anonymized databases of bit-strings, so that the anonymized databases can be stored remotely from a corporation's computer system, or shared securely and confidentially with another company. The mapping key that permits the anonymized bit strings to be converted back to their original form need not be disclosed outside of the corporation. The methods also permit two companies to exchange molecular structure data securely and in a manner that permits similarity calculations to be performed within as well as between the respective databases.

### CLAIM OF PRIORITY

This application claims the benefit of priority under 35 U.S.C. §119(e) to U.S. provisional application Ser. No. 61/660,783, filed Jun. 17, 2012, which is incorporated herein by reference in its entirety.

### TECHNICAL FIELD

The technology described herein generally relates to methods of calculating pairwise molecular similarity coefficients between molecules in a secure manner, and more particularly relates to methods of computing similarity measures that are based on 3-dimensional, 2-dimensional, or physicochemical molecular properties, condensed into a fingerprint or bit-string representation, in such a way that another party cannot deduce the underlying molecular structures. The methods have particular applicability to sharing of molecular informatic data between commercial competitors in situations where comparative information amongst pairs or groups of molecules, rather than actual structural data, is sought, or where one party does not want to disclose the molecular structures to the other.

### BACKGROUND

Among the plethora of ways to condense molecular structure information into compact representations for electronic storage and comparison by computer-based methods, the “fingerprint”, sometimes represented as simply as a bit-string, has endured for several decades. This is because fingerprints are very simple to store, retrieve, and manipulate within computer systems, and because large numbers of pairs of molecules can be compared extremely rapidly by overlaying their respective fingerprints and computing one or more metrics of overlap.

In the fingerprint representation, a molecule is expressed as a sequence (or, 1-dimensional array, or vector) of numbers, the position each of which in the sequence represents a particular property of the molecule. In its simplest form, a fingerprint is a string of bits (a “bit string”), where each bit is set to either zero (0) or one (1), and the position of each bit represents a structural feature or features, or some other property of the molecule. It will become clear that the methods described herein for permitting secure calculation of fingerprint comparisons are independent of the manner in which the fingerprints were derived, i.e., the precise molecular properties that are used to create the fingerprints in question. Nevertheless, it is instructive to describe a number of representative different types of fingerprints and the types of properties that can be used to create such fingerprints.

In one fingerprint representation, a bit string, each bit corresponds to the occurrence of a particular functional group, or moiety, or even the presence of certain numbers of such groups in the molecule. For example, a certain bit can correspond to the presence of exactly one methyl group in a molecular structure, and a different bit can be set to correspond to the presence of two or more methyl groups in a structure. For example, one of the earliest such bit-string representations was based on the “MACCS keys”, produced originally by MDL Software, now Accelrys, Inc. This representation uses a bit-string of 166 bits, each representing a functional group or count of such groups in the molecule. See for example the web-site: accelrys.com/products/pdf/keys-to-keyset-technology.pdf for a description. Molecular structures, stored either as sets of 3-dimensional coordinates or as connection tables, can be very quickly and efficiently parsed and converted into this type of bit-string so that a given bit is set to “on” (or 1) if the functional group or groups it encodes are present in the molecule. The remaining bits that represent functional groups absent from the molecule, are set to zero.

In another representation, also encoded as a bit string, the molecular structure is analyzed as a chemical graph, in which non-hydrogen atoms are nodes, and the bonds between them are edges. Substructures of the molecular structure also have graph theoretic properties. Substructures that are paths or trees of bonded atoms in the molecular structure can be readily enumerated, taking into account both atom and bond types within the substructures. A path is a linear connection of contiguous bonds without branches; a tree includes branches so that, for a given size (number of atoms), there are usually more trees than paths. It is possible to enumerate all such paths or trees within a given structure that have a user-specified number of bonds, typically up to 5. Although the number of such paths or trees may be very large, they can be collected and hashed into a smaller set of bits, typically 2,048 or 4,096. For example, the collection of atom and bond types that go into a single path can be condensed into a single feature; then, multiple such features can be hashed together to correspond to a single bit in the resulting bit-string. Such an approach has been implemented by OpenEye Scientific Software, Inc. (Santa Fe, N.M.), and is available in the GraphSim Tk (toolkit), See, e.g., the web-site: www.eyesopen.com/graphsim-tk.

The fingerprint representation is not limited to structural features. For example, individual components of a fingerprint can be numerical data for specified molecular properties (assuming that the same unit system is used for all molecules under consideration and/or that some normalization scheme can be applied to the range of values for the set of molecules in question). Thus a fingerprint could be composed of a collection of molecular descriptors such as but not limited to: magnitude of dipole moment; Log₁₀P; molecular weight; and various geometric parameters of one or more minimum energy conformations.

In another form of fingerprint, also having the binary form of a bit-string, individual bits can correspond to phenotypic aspects of a molecule's nature. For example, compounds can be routinely screened against batteries of tests: a ‘1’ at a pre-defined position in a bit-string can be used to indicate whether a molecule passed a particular test; conversely, a ‘0’ in that same position indicates failure against that particular test. Similarly, rather than derived from experimental data, the tests could themselves be the results of computer-based simulations, e.g., from docking scores, or from quantitative structure activity models. In other implementations, a given bit could be assigned ‘1’ or ‘0’ according to whether a particular score exceeds a threshold value, for example.

In yet another aspect, a 3-dimensional grid of spatial data for a molecule can itself be viewed as a fingerprint, if it is unfolded in a systematic way and stored as a sequence of numbers. In this aspect, each point in the grid has an associated number that corresponds to a molecular property (e.g., value of an electrostatic, steric, or hydrophobic field) at that point. The fingerprint could simply be a vector of such numbers and thereby provides a way to rapidly compare molecules according to 3-dimensional similarity, assuming some common alignment scheme. Alignment of all molecules stored in this way can be standardized according to some ‘canonical’ form of alignment, such as the inertial frame, prior to comparing their fingerprints.

In still another form of fingerprint, molecular properties can be histogrammed, and specific positions in the fingerprint assigned to bins of numeric values of a property.

In still other forms of fingerprint, molecular properties can derive from: shape fingerprints (either from grids, or from shape “semaphores” where a reference shape is assigned to each bit in the fingerprint cf. J. A. Haigh, B. T. Pickup, J. A. Grant and A. Nicholls, “Small Molecule Shape-Fingerprints”, J. Chem. Inf. Model., 2005, 45 (3), pp. 673-684, incorporated herein by reference) or shape histograms like those used in shape comparison outside the molecule space (See for example, “A Framework for Histogram-Induced 3D Descriptors”, C. B. Akgül et al., 14^{th} European Signal Processing Conference (EUSIPCO 2006), Florence, Italy, September 2006.), and 4-point pharmacophore fingerprints.

Implementation on a computer system of any of the methods described herein of deriving a fingerprint based on molecular properties and/or molecular structural features is within the capability of those skilled in the art.

In still further forms of fingerprint, bits can be assigned to represent similarity scores between the molecule and each member of a set of reference molecules. Given a suitable panel of reference molecules, a composite set of similarity scores to that reference set is itself distinctive of the molecule in question. The similarity scores can be, e.g., Tanimoto coefficients or other metrics as disclosed elsewhere herein, and can be based on 2D or 3D similarity measures, and in the case of 3D measures can be based on molecular shape representations such as steric or electrostatic fields.

Any of the foregoing types of information can be combined into a particular fingerprint representation for a molecule. For example, bond path and tree information can be used to make up a certain number of bits in a bit-string, where the remainder of the bits are based on phenotypic data and/or similarity data.

When working with bit-string representations, the identity of the functional groups or path/tree combinations or properties that correspond to individual bits in the string is established at the outset. Thus, before decomposing a set of molecular structures into a bit-string formalism, the “index” or “key” to the bit-string is set up. The order of the individual bits in the string is arbitrary, but for the representation to be effective for an assembly of molecules, the order of the bits needs to be kept constant across all molecules that are going to be retrieved or compared. Thus, an encoding scheme that is based on 100 important bond trees or functional groups must associate each tree or group with a single constant bit position in a bit-string representation of length 100. For example, if bit number 27 in the 100-bit string is associated with a phenyl group (in a functional group representation of molecular structure), then it is certain that any molecule whose structure is represented by a bit-string in this scheme does contain a phenyl group if bit number 27 is set to 1 for that molecule. Conversely, a molecule encoded in this way does not have a phenyl group if bit number 27 is set to 0.

Other convenient bit-string representations include the pharmacophore keys produced by Chemical Design Ltd., in the software Chem-X, which associate individual bits with geometric inter-atomic distances within a molecular structure. Each bit in the string corresponds to a binned distance (in Å) between a particular pair of atom-types.

The length of a workable fingerprint or bit-string is not limited but depends on a balance between the amount of information it is wished to encode and the computational resources available for storage and comparison. In general, the longer the fingerprint, the more likely it is that the fingerprint is unique: i.e., two different molecules cannot have the same fingerprint representation.

Comparisons of binary bit-strings can be accomplished according to one or more of several similarity metrics, of which the most popular is the Tanimoto coefficient. Other popular metrics include, but are not limited to: Cosine, Dice, Euclidean, Manhattan, city block, Euclidean, Hamming, and Tversky. In certain cases, molecules are “closer” to one another in similarity the greater the number of bits that they have in common in a given bit-string representation. Closeness can then be represented as an overlap, such as a number in the range [0,1] where 1 is a 100% overlap. In other cases, similarity is expressed as a “distance” where the smaller the number, the greater the number of structural features shared by the two molecules. Distance metrics in the context of 3-D shape descriptors have been described in, e.g., Goodall, S., et al., “3-D Shape Descriptors and Distance Metrics for Content-Based Artefact Retrieval”, in Storage and Retrieval Methods and Applications for Multimedia, San Jose, Calif., 16-20 Jan. 2005, SPIE-IS&T, 87-97 (incorporated herein by reference).

For the more general case in which the fingerprint contains numbers other than 1 and 0, (for example it contains electrostatic field data in 3 dimensions) then one can calculate similarity based on distance metrics between vectors of numbers. Other metrics, such as the Mahalanobis distance, may then be applicable.

The methods of sharing data securely as described herein are not dependent on the choice of metric used for comparing fingerprints.

Fingerprint representations such as the bit-string find widespread use in the pharmaceutical industry today where they play an indispensable role in the search for new, active, molecules. Pharmaceutical company databases can be enormous, often containing structural and physicochemical data for many millions of compounds stored on digital computers, which means that rapid ways of searching and comparing them are essential. The use of combinatorial synthesis procedures can also lead to very large databases of molecules having specifically tailored properties and/or based on a common scaffold. It has also become realistic to generate databases of ‘virtual’ compounds, i.e., molecular structures of compounds that have never actually been synthesized, but whose assembled structural properties need to be compared with those that have. The conversion to bit-string format for a given database, whether it contains data on real or virtual molecules, needs only be done once for a given definition of bit-string, and the bit-strings can then be stored on computer readable medium and retrieved and re-used.

An important step in the development of new drugs is the identification of compounds, not previously tested against a particular biological target, but which may share important structural features in common with a molecule of known activity. Correspondingly, other questions that pharmaceutical researchers ask include: how to exclude from consideration molecules that have, or are likely to have, structural features that are deleterious to drug efficacy for safe use in humans; and how representative a given database is in its inclusion of molecules having a particular set, or diversity, of properties.

Converting a large molecular database to fingerprint form, particularly a bit-string formalism, allows rather rapid answers to questions such as these. For example, a target molecule, converted to bit-string format, can be quickly compared with the bit-string representations of all of the molecules in the database. Additionally, the members of the database can themselves be pairwise compared amongst one another, to produce neighbor lists, and then clustered to illustrate the extent of coverage, as well as the gaps in coverage, that the database contains.

A fundamental question that arises, however, is whether a molecular structure can itself be reconstructed if only the fingerprint is known. Where the fingerprint contains numeric data, for example for physicochemical properties, it may be rather difficult to deduce very much at all about the original molecule unless the physicochemical data is itself publicly accessible. If the fingerprint is a bit-string based on two-dimensional molecular features (such as paths or presence or absence of particular functional groups), it is generally true that, having the bit-string and knowing the key to the bit-string only permits one to ascertain for certain which functional groups or bond paths/trees a given molecule contains, and not the way in which those groups or bonds are connected to one another, and certainly not 3-dimensional aspects of structure such as stereochemistry and the handedness of chiral centers. When the bit-string is based on bond trees or bond paths, there is an additional complication in that the hash function that is used to fold multiple paths or trees into a single bit may not be easy to deduce.

Nevertheless, it has been recognized that molecular fingerprints do contain valuable information that may be assessable even without knowing the key. This is particularly true if bit-strings are long and comprehensive (in which case the number of distinct molecules that could be represented by a particular string may be quite small). For such bit-strings, matching a test compound with those in a database would directly reveal the test compound's likely presence if a similarity score of 1.0 were calculated. It is also true if it is known that the bit-strings in question are all representing a general class of molecule, in which case small differences between largely similar bit-strings may be very revealing. Even where the bit-string is based on bond paths and trees that have been hashed, a skilled user may still be able to create fingerprints for a large set of structures and look for common features that turn on bits, resulting in the possibility to reconstruct the original molecules with some confidence from another collection of bit-strings. Furthermore, in some instances use of rather sophisticated techniques such as genetic algorithms can lead to deduction of an underlying structure, or a short-list of likely candidates, from a bit-string representation based on functional groups. Such techniques could be frustrated by inserting a few additional randomly positioned bits to a bit-string for an actual molecule. Such bits would be “dummies” in the sense that they do not represent specific structural information and can be set arbitrarily to “1” or “0” for a given molecule. Even though this might have a deleterious effect on the accuracy of similarity calculations with respect to that molecule (and others that have similarly had random bits inserted into their fingerprints), it would reduce the possibility that the chance occurrence of an exact match reveals the identity of an actual molecule in a dataset.

Correspondingly, then, it might seem as if disclosing only the bit-string for a molecule instead of its structure would afford the discloser some measure of security because the actual structure of the molecule could not be definitively deduced from its bit-string alone, or only rarely or with considerable difficulty. However, many parties have come to view the bit-string as containing structural information that is valuable enough, if decoded, that even disclosing the bit-string form of a molecule entails sufficient risk that it is to be avoided.

Restrictions on disclosure of, or a reluctance to disclose, molecular structure information becomes an impediment in a number of areas of commerce. In one instance, for example, a company possessing a computer database of molecular structures may wish to share some aspects of that data with another company with whom it is planning a joint venture, collaboration, merger, or license. Before the deal is actually signed and while diligence on the deal is being carried out, confidentiality of the molecular structure information remains critical to the disclosing company.

In another instance, a company or corporation that has a computer database of stored molecular structural data wishes to carry out some highly computationally intensive calculations and manipulations on that data that would exceed its own internal computational resources. Such a company might try to avail itself of off-site computing resources available via an Internet connection (often referred to as “the cloud”) to carry out these calculations. However, the underlying data would have to be moved outside of the company's secure computer systems and on to remote computers (in “the cloud”), i.e., into a location where the company could not guarantee the security of the data to its own satisfaction. In this situation too, the company may regard transfer of fingerprint or bit-string representations outside of its firewall to be too risky.

Accordingly, to address these sorts of situations, as well as others not specifically mentioned herein, there is a need for a method of securing fingerprint representations so that they can be securely shared, or temporarily stored, outside of a company's computer systems, without revealing actual details of molecular structure, but also without compromising the underlying data. In other words, molecules that are similar to one another should retain that same precise level of similarity in the secured representation as they do in the original, unsecured, representation even though their actual structures have been masked.

The discussion of the background herein is included to explain the context of the technology. This is not to be taken as an admission that any of the material referred to was published, known, or part of the common general knowledge as at the priority date of any of the claims found appended hereto.

Throughout the description and claims of the application the word “comprise” and variations thereof, such as “comprising” and “comprises”, is not intended to exclude other additives, components, integers or steps.

### SUMMARY

The instant disclosure addresses methods of anonymizing fingerprints of molecular descriptors that represent molecular structures. The fingerprints can comprise bit strings (for example strings of bits that represent functional groups or bond paths and trees, binary physical properties), histograms, coordinates in N-dimensional space, collections of descriptor values, phenotypic fingerprints, shape fingerprints, shape histograms, 4-point pharmacophore fingerprints and combinations thereof.

The disclosure comprises a method of reordering the positions of the descriptors in a given fingerprint representation, according to a known sequence of permutations (a mapping), applying that sequence of permutations to all the fingerprints having that representation, and saving the permuted fingerprints for further use.

In particular, for a bit-string representation, the disclosure comprises a method of reordering the bits having a given bit-string index, according to a mapping key, applying the mapping to all bit-strings generated according to that index, and re-storing the mapped bit-strings.

The disclosure further comprises an apparatus, such as a computing apparatus having a memory and a processor, programmed with instructions for performing such a method of anonymizing molecular fingerprints.

The disclosure further comprises a computer readable medium (other than a transitory medium such as a signal) that stores instructions that, when executed by a computer processor, carries out such a method of anonymizing molecular fingerprints.

The apparatus and process of the present disclosure are particularly applicable to generating secured or anonymized databases of fingerprints, so that the anonymized databases can be stored remotely from a corporation's computer system, or shared securely and confidentially with another company or other third party. Neither the original index for the fingerprint, nor the mapping key that permits the anonymized fingerprints to be converted back to their original form, are disclosed outside of the corporation.

### BRIEF DESCRIPTION OF THE DRAWINGS

FIG. 1 shows a flow-chart of a process as described herein;

FIG. 2 shows a computing apparatus for performing a process as described herein; and

FIG. 3 shows a flow-chart of a process as described herein.

FIG. 4 shows a flow-chart of a process as described herein.

Like reference symbols in the various drawings indicate like elements.

### DETAILED DESCRIPTION

The instant technology is directed to methods of securing the calculation of pairwise molecular similarity coefficients between molecules, and more particularly relates to methods of computing similarity measures that are based on 3-dimensional, 2-dimensional, or physicochemical molecular properties that have been condensed into a fingerprint, such as a bit-string, representation, in such a way that another party, or in some instances an identified third party, cannot deduce information about the underlying molecular structures.

### Anonymizing a Fingerprint

The following description, and the Examples herein, are illustrated, for simplicity, by manipulations on a bit-string representation. One of skill in the art would appreciate that the same overall principles can be applied to anonymizing a fingerprint whose individual components are other than ‘1’ and ‘0’s, as long as an index of the original positions is maintained, and as long as the similarity between different fingerprints is invariant to the ordering of the components in all such fingerprints.

Where a key (or index) to a bit-string representation is known, a specific permutation of that key, when applied to all molecular bit-string representations, for example in a computer database, will lead to a new representation. Thus, where bit number 271, for example, in a 1,024-bit string encodes a particular 5-atom path, say C═C—C═N—C, in the original representation, if all bits numbered 271 are moved to position number 611, say (and the original bits stored at position 611 are moved elsewhere, and so on), then in the new representation, molecules having bit number 611 set to one (1) contain the C═C—C═N—C 5-atom path, and, correspondingly, those having bit number 611 set to zero (0) do not have that path. Since all comparison functions for fingerprints just compare the presence or absence of a bit between the pair, as long as all fingerprints being compared are permuted in the same way similarity comparisons are unaffected by the transformation.

The choice of permutation(s) to achieve such anonymization is essentially arbitrary. A permutation operator for a fingerprint could be generated randomly, using any of a number of random number generating algorithms known in the art. In practice, randomization is best controlled by use of a random seed (known only to the anonymizer). There are of course, a very large number of such randomly generated permutations for a given length of fingerprint.

A permutation operator could also be generated somewhat more quickly, by applying one or more simple operations to a fingerprint. For example, all bits, or a sub-string of bits, in a bit-string could be shifted a specified number of positions to the left or right. As another example, an arbitrary (or randomly chosen) cut-point in the bit-string could be identified, the string “cut” at that point, and then the two parts swapped with respect to one another and rejoined. In yet another possibility, the bit-string, or a sub-string within it, could be rewritten from right-to-left. These simple operators, and combinations thereof, would be easier to generate than a fully random set of permutations, and may be easier to apply to a large number of strings stored in a database.

The greater the number of positions changed by the permutation operator, the harder it will be for a third party to deduce molecular structural information. For example, if a permutation operator that just swapped the positions of two bits in a bit-string were applied, then the net change in the representation of many or most structures would be small or non-existent. Consequently, it is preferable that the permutation operator deployed is one that alters the positions of at least half of the bits in the bit-string. For a string having n positions, it is preferable that the anonymization operator alters the position of at least 30% of n positions, and preferably 50% of n positions, more preferably 60% of n positions, still more preferably 70-80% of n positions, and even more preferably, 90% or more of n positions.

Although someone who did not know the permutation operation(s) that had been used to randomize the fingerprints would not be able to deduce structural information from the randomized fingerprints, certain features may yet provide clues: in particular, in a substructure-based bit-string the frequency of occurrence of certain bits may provide hints as to which bits represent the naturally most frequently occurring substructures. The risk of such information being reliably deduced decreases as the length of the bit-string increases. For all practical purposes, a rearranged bit string having 2,048 bits is very difficult to decode.

As discussed hereinabove, some additional measure of security can be obtained if a small number of randomly positioned bits are inserted into the set of bit-strings (at known/indexed locations) and before anonymization.

Another way in which the actual identity of the original fingerprint representation can be further protected is to introduce into the dataset a number of apparently random fingerprints that do not represent actual molecules but instead chimeric entities. Truly random fingerprints can themselves be made by suitable application of random number generation algorithms; for example, a seed number (different from the seed number used to permute the fingerprints) could be used. Random fingerprints have the drawback that they may have very low actual similarity with known molecules and would therefore be easy to spot. More effective fictitious bit-strings are those that have been designed to mask the actual frequency of occurrence of characteristic bits, such as by making the frequency of any particular bit look even across all of the bit-strings. Such strings may still not code for actual molecules but they may also appear sufficiently molecular to defy easy recognition as chimeric entries in the database. The combined occurrence of the bits or numeric values in the “fictitious” fingerprints with those in the real fingerprints serve to mask the actual frequencies of the bits that correspond to real structures, and/or the numerical values that correspond to actual molecular properties. Further sources of randomization are the positions in the database at which the fictitious fingerprints are inserted, as well as the number of such fictitious fingerprints as a proportion of the overall database. Once the fictitious fingerprints have been introduced, the database owner must maintain an index of the positions where they are located in the database so that, when results of analysis on the database are returned, those similarity coefficients that involve one or more fictitious fingerprints can be removed.

What is important about any permutation operations that are used is that, when applied to the entire database of fingerprints, comparisons between pairs of molecules having the permuted fingerprints are unaffected by such a transformation. Thus, a pair of molecules whose similarity is expressed by a Tanimoto coefficient of 0.84 in an original bit-string representation, have the same similarity value when it is calculated from their respectively permuted bit-strings.

The permuted fingerprints can be communicated to a third party who does not know the permutation operation(s) that have been applied. By this is meant that the permuted fingerprints can be transferred via a computer network connection from, e.g., one party's computer system to another. They could be transmitted from one party to another via e-mail, or via, for example, a web interface or drop-box type facility. They could also be transmitted via a transportable computer readable medium such as a CD-Rom or USB-drive. Once the third party receives the data, the third party can then carry out clustering and pairwise similarity calculations on the permuted fingerprints without being able to divine information about the actual structures.

Certain safeguards may need to be deployed. For example, a set of dummy bit-strings, each of which has only a single bit set to ‘1’ could be inserted into a database and used as ‘keys’ to unlock those molecules having a particular bit set. Preprocessing tools could be deployed to strip a database of any such fingerprints, defined as, say, any fingerprint having fewer than 1% of the total number of bits set to ‘1’.

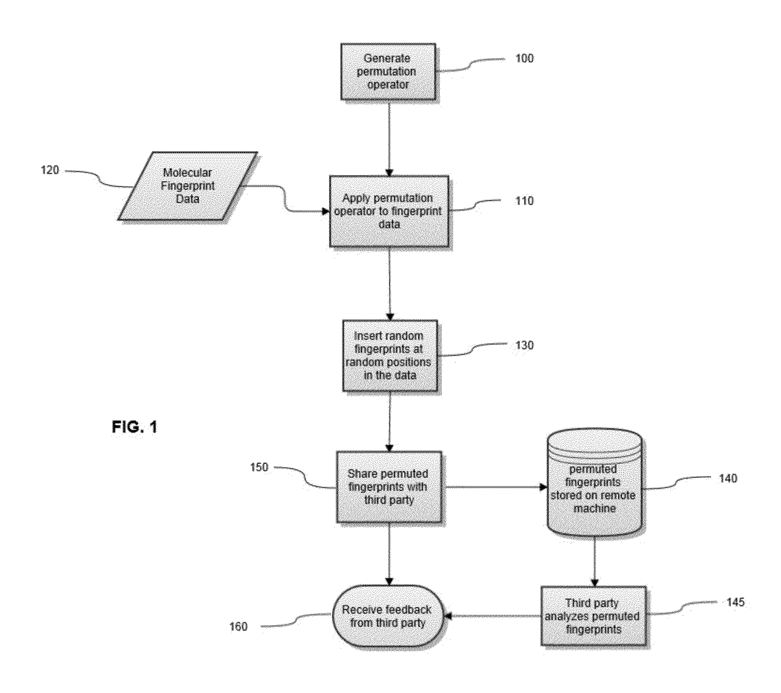

An overview of the technology herein is provided in FIG. 1, which shows a flow-chart of operations to be performed on a computer. At 100, a permutation operator is generated, by a computer, at random. This operator, as described elsewhere herein, has the effect of permuting some or all of the positions in a vector such as a molecular fingerprint or bitstring. This operator is applied 110 to molecular fingerprint data 120, such as stored in a company's electronic database, thereby generating permuted fingerprint data. Optionally, randomly generated fingerprints, i.e., corresponding to no known molecule, are inserted 130 at random positions into the permuted fingerprint data. This step could optionally be performed before step 110, in which case the permutation operator could also be applied to the randomly generated fingerprints. At 150, the permuted fingerprint data is shared with a third party, for example by storing the permuted fingerprints on a remote machine, not under the control of the party whose fingerprint data has been permuted. The third party analyzes the permuted fingerprints 145, for example by applying diversity analysis to the entire database of fingerprints, and may optionally share 160 results of the analysis with the party whose fingerprint data has been permuted.

### Computational Implementation

The computer functions for manipulations of molecular fingerprints, such as bit-strings, can be developed by a programmer skilled in the art. The functions can be implemented in a number and variety of programming languages, including, in some cases mixed implementations. For example, the functions as well as scripting functions can be programmed in C, C++, Java, Python, Perl, .Net languages such as C#, and other equivalent languages. The capability of the technology is not limited by or dependent on the underlying programming language used for implementation or control of access to the basic functions. Alternatively, the functionality could be implemented from higher level functions such as tool-kits that rely on previously developed functions for manipulating bit-strings and fingerprints.

The technology herein can be developed to run with any of the well-known computer operating systems in use today, as well as others, not listed herein. Those operating systems include, but are not limited to: Windows (including variants such as Windows XP, Windows95, Windows2000, Windows Vista, Windows 7, and Windows 8, available from Microsoft Corporation); Apple iOS (including variants such as iOS3, iOS4, and iOS5, iOS6, iOS7, and intervening updates to the same); Apple Mac operating systems such as 0S9, OS 10.x (including variants known as “Leopard”, “Snow Leopard”, “Mountain Lion”, and “Lion”; the UNIX operating system (e.g., Berkeley Standard version); and the Linux operating system (e.g., available from Red Hat Computing).

To the extent that a given implementation relies on other software components, already implemented, such as functions for applying permutation operations, and functions for calculating overlaps of bit-strings, those functions can be assumed to be accessible to a programmer of skill in the art.

Furthermore, it is to be understood that the executable instructions that cause a suitably-programmed computer to execute methods for anonymizing a molecular fingerprint, as described herein, can be stored and delivered in any suitable computer-readable format. This can include, but is not limited to, a portable readable drive, such as a large capacity “hard-drive”, or a “pen-drive”, such as connects to a computer's USB port, and an internal drive to a computer, and a CD-Rom or an optical disk. It is further to be understood that while the executable instructions can be stored on a portable computer-readable medium and delivered in such tangible form to a purchaser or user, the executable instructions can be downloaded from a remote location to the user's computer, such as via an Internet connection which itself may rely in part on a wireless technology such as WiFi. Such an aspect of the technology does not imply that the executable instructions take the form of a signal or other non-tangible embodiment. The executable instructions may also be executed as part of a “virtual machine” implementation.

### Computing Apparatus

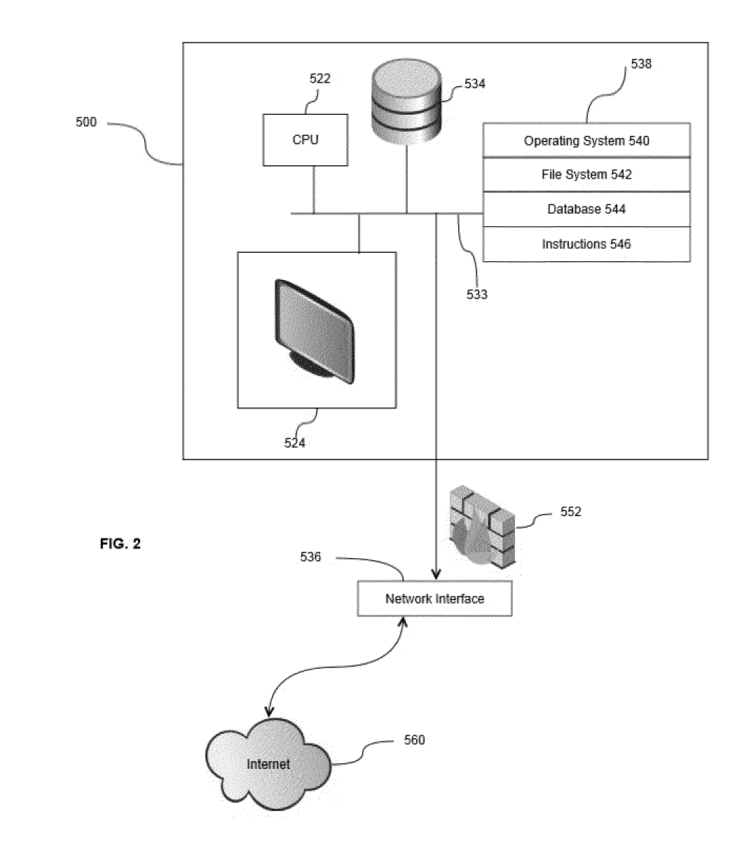

An exemplary general-purpose computing apparatus 500 suitable for practicing methods described herein is depicted schematically in FIG. 2.

The computer system 500 comprises at least one data processing unit (CPU) 522, a memory 538, which will typically include both high speed random access memory as well as non-volatile memory (such as one or more magnetic disk drives), a user interface 524, one more disks 534, and at least one network connection 536 or other communication interface for communicating with other computers over a network, including the Internet 560, as well as other devices, such as via a high speed networking cable, or a wireless connection. Network connection 536 can be used for one company to share data (such as permutation operator, and molecular fingerprint data) with another company. There may optionally be a firewall 552 between the computer 500 and the Internet 560. At least the CPU 522, memory 538, user interface 524, disk 534 and network interface 536, communicate with one another via at least one communication bus 533.

Memory 538 stores procedures and data, typically including some or all of: an operating system 540 for providing basic system services; one or more application programs, such as a parser routine 550, and a compiler (not shown in FIG. 2), a file system 542, one or more databases 544 that store molecular structures or fingerprints, and optionally a floating point coprocessor where necessary for carrying out high level mathematical operations. The methods of the present technology may also draw upon functions contained in one or more dynamically linked libraries, not shown in FIG. 2, but stored either in memory 538, or on disk 534.

The database and other routines shown in FIG. 2 as stored in memory 538 may instead, optionally, be stored on disk 534 where the amount of data in the database is too great to be efficiently stored in memory 538. The database may also instead, or in part, be stored on one or more remote computers that communicate with computer system 500 through network interface 536, according to methods as described in the Examples herein.

Memory 538 is encoded with instructions 546 for anonymizing fingerprint or bitstring representations of molecules stored electronically in a database, and for calculating a similarity score for the anonymized fingerprints. The instructions can further include programmed instructions for performing one or more of generating a random number and for calculating fingerprint or bitstring representations of the molecular structures stored in the database. In many embodiments, the fingerprints themselves are not calculated on the computer 500 that performs anonymization but are performed on a different computer and, e.g., transferred via network interface 536 to computer 500.

Various implementations of the technology herein can be contemplated, particularly as performed on computing apparatuses of varying complexity, including, without limitation, workstations, PC's, laptops, notebooks, tablets, netbooks, and other mobile computing devices, including cell-phones, mobile phones, and personal digital assistants. The computing devices can have suitably configured processors, including, without limitation, graphics processors and math coprocessors, for running software that carries out the methods herein. In addition, certain computing functions are typically distributed across more than one computer so that, for example, one computer accepts input and instructions, and a second or additional computers receive the instructions via a network connection and carry out the processing at a remote location, and optionally communicate results or output back to the first computer.

Control of the computing apparatuses can be via a user interface 524, which may comprise a display, mouse, keyboard, and/or other items not shown in FIG. 2, such as a track-pad, track-ball, touch-screen, stylus, speech-recognition device, gesture-recognition technology, human fingerprint reader, or other input such as based on a user's eye-movement, or any subcombination or combination of inputs thereof.

The manner of operation of the technology, when reduced to an embodiment as one or more software modules, functions, or subroutines, can be in a batch-mode—as on a stored database of molecular structures or fingerprints, processed in batches, or by interaction with a user who inputs specific instructions for a single molecular structure or fingerprint.

The similarity calculations created by the technology herein, as well as the anonymized fingerprints themselves, can be displayed in tangible form, such as on one or more computer displays, such as a monitor, laptop display, or the screen of a tablet, notebook, netbook, or cellular phone. The similarity scores and anonymized fingerprints, can further be printed to paper form, stored as electronic files in a format for saving on a computer-readable medium or for transferring or sharing between computers, or projected onto a screen of an auditorium such as during a presentation.

ToolKit: The technology herein can be implemented in a manner that gives a user access to, and control over, basic functions that provide key elements of a similarity score, as well as a way to transform a molecular fingerprint or database of such fingerprints into an anonymized form suitable for secure sharing.

The toolkit can be operated via scripting tools, as well as or instead of a graphical user interface that offers touch-screen selection, and/or menu pull-downs, as applicable to the sophistication of the user. The manner of access to the underlying tools by a user is not in any way a limitation on the technology's novelty, inventiveness, or utility.

Certain default settings can be built in to a computer-implementation, but the user can be given as much choice as he or she desires over the features that are used in calculating the similarity and of anonymizing the fingerprints.

### EXAMPLES

### Example 1

### Permuting a Bit-String

Let an original bit string representation have n bits and be denoted by b(1, 2, . . . i, . . . , . . . j, . . . n).

Let a permutation operator P(i,j) swap the positions of bits i and j in a bit-string. Any permutation of two or more bits in b can be expressed as the product of one or more permutation operators P(i,j) that act on pairs of bits.

An anonymization transformation operator would be represented by: π_{i,j=1,n}P(i,j). It can be assumed that not all such transformation operators would act on all bits in a bit-string: i.e., the index for some bits may remain unchanged after the transformation has been applied.

A new, permuted, bit-string, a(1, 2, . . . i, . . . , . . . j, . . . n) would be expressed as:

a(1, 2, . . . i, . . . , . . . j, . . . n)=π_{i,j=1,n}P(i,j)b(1, 2, . . . i, . . . , . . . j, . . . n)

An inverse transformation can be applied to a to regenerate b, as required.

This notation is used throughout the subsequent examples.

### Example 2

### Taking Anonymized Bit-Strings to an External Location Securely

A company wishes to run a computationally intensive analysis of a database of molecular structures at a location outside of its secure computing environment, possibly in order to conserve its own resources or possibly because it lacks the computational resources internally to carry out the analysis. This Example follows the steps shown in FIG. 1.

The company ensures that all of the molecular structures in its database, or at least a relevant subset of the molecular structures in the database, have been converted to a bit-string formalism, whose key is known.

The company then derives an anonymization transformation operator, π_{i,j=1,n}P(i,j), that is composed of a number of pairwise swaps of bit-positions in the bit-string.

The anonymization transformation operator is applied to all bit-strings in the database, or all those that are intended to be transferred outside of the company as the case may be, and the anonymized bit-strings are stored. Optionally, the company may create a number of fictitious bit-strings (randomly generated bit-strings that do not represent real structures in the database) and insert them at known positions in the database before transferring it outside.

The anonymized bit-strings are transferred to a remote server (for example, accessible via an Internet connection), outside the company, for subsequent analysis by an outside computer, for example by carrying out various similarity calculators or applying statistical tools that are configured to accept bit-strings as input.

Neither the anonymization transformation operator nor the key to the original bit-string leaves the company, but are both stored, for example on a secure server, within the company. The party that controls the site where the calculations are carried out cannot deduce any structural information about the molecules that are encoded in the bit-strings.

### Example 3

### Sharing Anonymized Bit-Strings Securely

A first company wishing to share bit-string molecular structure information with another, second, company, securely, and only for the purpose of analysis without risk of divulging molecular structural data, can proceed as in Example 2. This Example also follows the steps shown in FIG. 1. Thus, the first company transfers an assembly of anonymized molecular bit-strings to a site outside, at the second company (with or without a number of fictitious bit-strings having been inserted beforehand). The anonymization transformation operator is kept secure within the first company, as is the key to the original bit-string representation.

In this instance, the second company can perform manipulations of the anonymized data and deduce similarity information amongst the structures or cluster the structures, but without gleaning molecular structural information about specific structures. The second company also cannot perform direct comparisons between its own molecular structure data and the first company's data in any meaningful way.

This approach can be usefully applied if the second company is a service provider, such as a company having computational analysis tools or expertise that are lacking within the first company.

### Example 4

### Sharing Anonymized Bit-Strings Securely (2)

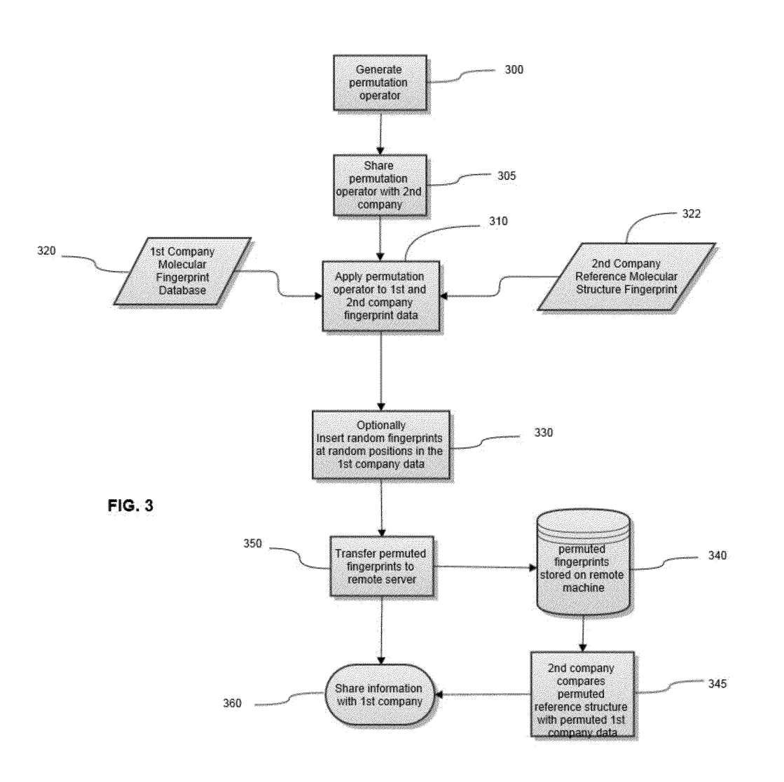

In this example, a second company has a reference molecular structure and wishes to ascertain whether the first company's database is target-rich, i.e., has a significant population of molecules that are similar to the reference molecular structure. This assumes, of course, that both the first and second companies are using the same underlying fingerprint definitions to store their molecular structure information. It may be necessary for either or both companies to adopt a common fingerprint definition and create a database of fingerprints meeting that definition prior to conducting the collaboration. This example is illustrated in FIG. 3.

In this instance, both the database structures and the reference molecular structure must be anonymized, but using the same anonymization operator.

The calculation of matches between the anonymized reference structure and those anonymized structures in the database can be carried out securely on a remote location provided that both companies are comfortable knowing the anonymization operator before sending their respective data outside. In this environment, other third parties cannot gain access to the molecular structure information without obtaining the anonymization operator from one or other of the two companies. However, in this example, both companies must be comfortable that, because the anonymization operator is known to both parties, either one could potentially identify molecular structural information in the other's data. Methods of accomplishing such comparisons without divulging the anonymization operator between the parties are described in the subsequent examples.

In the illustration of FIG. 3, a first company (which holds a database of molecular fingerprints 320) generates a permutation operator 300, and shares it 305 with a second company. In alternative embodiments, the permutation operator is not shared with the second company and, instead, the second company shares the fingerprint for a reference molecule 322 with the first company. At 310, the permutation operator is applied to both the first company molecular fingerprint database and the second company's reference molecular fingerprint. This can be carried out separately by both respective company computer systems, or (in the circumstance that the permutation operator has not been shared with the second company) entirely on the first company's computer system. Random fingerprints can also, optionally, be inserted 330 into the first company's database of fingerprints before the second company carries out any analysis.

The permuted fingerprints (for both the first company's fingerprint database, and the second company's reference molecule) are transferred 350 to a remote server, outside the firewalls of both first and second company's computer systems. While the permuted fingerprints are stored on the remote machine 340, the second company compares 345 its permuted reference molecule fingerprint with those of the first company database, an shares 360 results, as applicable, with the first company

### Example 5

### Sharing Anonymized Bit-Strings Securely (3)

In this example, a first company (A) and a second company (B) both have molecular structure databases, N and M respectively, that they wish to compare, for example to determine the quantity of common or similar molecular structures shared between the two databases. In one instance, A might be looking for a database of structures that contains a large number of molecules having structural characteristics similar to those of current interest to A. In another instance, B may be looking for complementary molecular structures, such as those having structural features different from those already within its possession. Thus, the value of the information in A's collection (N) to B is highly dependent on the contents of B's own collection (M), and vice versa. Neither A nor B is willing (or able) to openly share the entire contents of their databases with the other, or even with a trusted third party. The inability to share the information makes the determination of the value impossible without some anonymization, and some further encryption.

As in Example 4, A and B together agree on a shared technique to anonymize their data in such a way that even a clever outside party would not be able to determine the contents of the data. For example, both A and B apply the same anonymization operator to their respective databases. Nevertheless, both A and B would still be exposed to each other if they shared their datasets with one another.

To resolve this issue, A and B engage a third party (C). C provides both A and B with a shared public key which is then used to encrypt the information, using a public key/private key (“asymmetric”) cryptography scheme. Once the datasets have been encrypted, they are delivered (separately or together) to C. C uses its private key to decrypt both data sets and perform the desired comparisons. As the datasets were already encrypted by A and B before the data was transmitted to C, C can only perform comparisons by decrypting the respective encrypted datasets. If C does this on its own machines, no further encryption or anonymization needs to be done. However, if C will use other, less secure, resources, such as in the “cloud”, C may need to perform a second anonymization of the data, using an anonymization operator known only to C and also, preferably, a randomization of the order of the structures in the respective databases. This provides protection for both A and B in the event that either one is able to access the other's data in the cloud. Once the comparisons have been made, C reports the results of the comparisons to both A and B, having reversed the effect of the second anonymization, if applied.

As both A and B may have differing levels of concern about the information reported to the other party, that information may be limited by prior agreement between A and B. The following are examples of information that might be provided.

Self similarity in one's own data set (results of comparing N×N, M×M)

Only A would receive the N×N results

Only B would receive the M×M results

Similarity to the other Party's data set (results of comparing N×M, M×N)

The number of results shared would be limited by agreement/pricing, as well as by a threshold. For example, only those pairs of molecules having a similarity score greater than a particular threshold are revealed to the respective parties.

A would get a list of similar data in B's set and B would get a list of similar data in A's set, but neither would see the other party's list

For each A[i] (i.e. index i in A's data set), A would receive a list (j, k, l, . . . ) that corresponds to the appropriate indices in B's data set.
B would receive similar data for each B[i] but would not receive any information about any A[i].

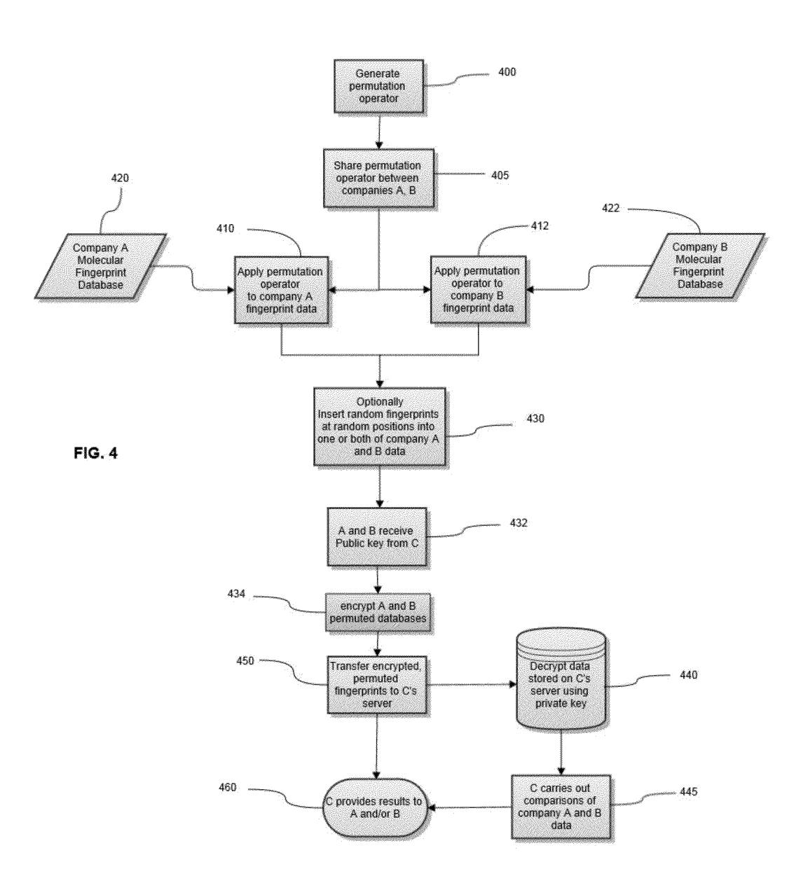

A flow chart illustrating this example is shown in FIG. 4. A permutation operator is generated 400 and shared 405 between companies A and B. This assumes, of course, that both companies A and B are using the same underlying fingerprint definitions to store their molecular structure information. It may be necessary for either or both companies to adopt a common fingerprint definition and create a database of fingerprints meeting that definition prior to conducting the collaboration.

The permutation operator is applied 410 to the company A fingerprint data 420, and applied 412 to the company B fingerprint data 422. Random fingerprints may be optionally inserted at random positions into one or both of company A and company B databases.

Companies A and B then receive 432 a public key from a third party C, and encrypt 434 their respective permuted databases using that public key. The now-encrypted, permuted fingerprint data is transferred 450 to C's computer system, where it is decrypted 440 using C's private key. C can now carry out requested comparisons 445 of company A and company B's data, if necessary under instruction or guidance from A and/or B. Results of the comparison are provided 460 to companies A and/or B, by agreement.

### Example 6

### Sharing Anonymized Bit-Strings Securely (4)

This is an extension of Example 5 where the identity of one party (e.g., B) cannot be disclosed to C (or any other third party) for any of a variety of reasons (for example, company A is interested in buying B). Again, C generates a public/private key pair and makes the public key available to both A and B. Relevant portions of FIG. 4 illustrate this example.

This solution is the same as for Example 5, except that instead of both A and B delivering their encrypted information independently to C, B delivers its encrypted dataset to A who then provides both sets to C. B can encrypt its dataset without having to contact C by virtue of the fact that C has published its public key. C uses the private key decrypt the dataset and to carry out the comparisons, as in Example 5.

In this scenario, the only results provided to A are those that would have been returned to A had this been a symmetric scenario in which both parties were known.

### Example 7

### Sharing Anonymized Bit-Strings of Multiple Parties Securely

An entity (NP), for example a non-profit organization that is working on orphan diseases, has been given access to the ability to screen (physically) compounds from a number of companies, but is not permitted to know the structures. NP wants to do some similarity calculations to know how much diversity exists in the total set.

This is much like Example 5, but instead NP has multiple providers. NP can work with each of them to use the same anonymization key to anonymize their set of molecules. These K sets of molecules, say from companies D-J, are sent to a trusted third party, C. Much like in Example 5, the trusted third party then performs an entire comparison across all the structures in all the databases, as well as subset comparisons within individual databases and provides this information back to the original entity, NP. NP doesn't know any structures but can at least understand how much duplication might exist in the set of provided structures which could save physical resources by screening a smaller set. The original companies D-J get no information back about how their respective sets compare to those of other companies.

Relevant portions of FIG. 4 illustrate this example also.

The foregoing description is intended to illustrate various aspects of the instant technology. It is not intended that the examples presented herein limit the scope of the appended claims.

In particular, it is apparent that, although the examples have been described in the context of molecular structure data, and scenarios in which secure sharing of molecular databases is called for, the methods herein could be applied successfully to the secure sharing of other fingerprint data where the underlying objects to be compared are other than molecules. Any such data that can be described as a set of coordinates in N-dimensional space and that can be compared via a distance metric that doesn't depend on the order of the coordinates can be anonymized and securely shared using the methods herein.

All references cited herein, including non-patent literature, web-sites, and patent publications, are incorporated by reference in their entireties.

The invention now being fully described, it will be apparent to one of ordinary skill in the art that many changes and modifications can be made thereto without departing from the spirit or scope of the appended claims.

What is claimed:

1. A method, performed on a computer, of transforming a fingerprint representation of a molecule, the method comprising:
generating a permutation operator;
applying the permutation operator to the fingerprint, wherein the fingerprint is stored in a computer memory, thereby generating a permuted fingerprint; and
storing the permuted fingerprint in computer memory.

2. The method of claim 1, wherein the fingerprint is a bit-string.

3. The method of claim 2, wherein the bit-string comprises positions that correspond to one or more of: presence of a particular functional group or groups in the molecule; presence of one or more particular bond paths in the molecule; presence of one or more particular bond trees in the molecule; whether the molecule is active or inactive in a particular test according to screening data; and whether a docking score is above a threshold value in a virtual screen.

4. The method of claim 1, wherein the fingerprint comprises positions that correspond to one or more of: numerical physicochemical data for the molecule; electrostatic field data at a position in a grid representation of the molecule; and histogrammed data for a molecular property.

5. The method of claim 1, wherein the molecular fingerprint is stored in a database on a computer, and wherein the method is applied to at least one other molecular fingerprint in the database.

6. A method for securely sharing molecular structure information, the method comprising:
generating a permutation operator;
applying the permutation operator to a fingerprint representation of the molecular structure stored on a computer, thereby creating a permuted fingerprint; and
sharing the permuted fingerprint, but not the permutation operator, with a third party.

7. A method for securely sharing a database of molecular structures, the method comprising:
generating a permutation operator;
applying the permutation operator to a fingerprint representation of each of the molecular structures in the database; and
sharing the permuted fingerprint representations, but not the permutation operator, with a third party.

8. The method of claim 7, further comprising inserting one or more fictitious fingerprint representations at random positions in the database.

9. A method of calculating the similarity between a target molecule and molecules in a database, the method comprising:
generating a permutation operator;
applying the permutation operator to a fingerprint representation of the target molecular structure and fingerprint representations of the molecules in the database; and
calculating the similarity between the target molecule and the molecules in the database by computing an overlap of their respective permuted fingerprints.

10. A computing apparatus for transforming a molecular fingerprint, the apparatus comprising:
a memory; and
a processor;
wherein the processor is configured to execute instructions stored in the memory, and wherein the instructions comprise instructions for:
generating a permutation operator;
applying the permutation operator to the fingerprint; and
storing the permuted fingerprint.
